(19) United States
(12) Patent Application Publication
(10) Pub. No.: US 2023/0401281 A1
(43) Pub. Date: Dec. 14, 2023

(54) MATRIX OPERATION-BASED METHOD FOR MODIFYING MOBILE SOCIAL NETWORK GRAPH

(71) Applicant: FUJIAN NORMAL UNIVERSITY, Fuzhou (CN)

(72) Inventors: Li XU, Fuzhou (CN); Xiaolin LI, Fuzhou (CN); Binting SU, Fuzhou (CN); Hongyan ZHANG, Fuzhou (CN); Hui LIN, Fuzhou (CN)

(73) Assignee: FUJIAN NORMAL UNIVERSITY, Fuzhou (CN)

(21) Appl. No.: 18/033,556

(22) PCT Filed: Aug. 23, 2022
(86) PCT No.: PCT/CN2022/114230

§ 371 Date: Apr. 25, 2023

(30) Foreign Application Priority Data
Aug. 31, 2021 (CN) 202111014008.X

(51) Int. Cl. G06F 17/16; G06Q 50/00

(52) U.S. Cl. CPC G06F 17/16; G06Q 50/01

(57) ABSTRACT

A matrix operation-based method for modifying a mobile social network graph, including step S1: obtaining a accessibility matrix set A of a social network graph to be modified; step S2: determining information to be modified for each node in the social network graph to be modified, and creating a List to be modified; step S3: for each node in the social network graph to be modified, determining whether edge adding is required according to the List to be modified; and step S4: if there is still a non-zero value in the List after all nodes are traversed, directly adding Max(List) nodes to a network, and randomly performing edge connection between the added nodes and nodes still requiring edge adding, so that all values in the List are zero, thereby completing graph modification.

### FIELD OF TECHNOLOGY

The present invention relates to the field of data center network security, in particular to a matrix operation-based method for modifying a mobile social network graph.

### BACKGROUND

With the rapid development of network and computer technology, people's daily life and the Internet are constantly fused with each other. People publish their interests, hobbies, places and other information through various social software and platforms such as WeChat, QQ, and Sina Weibo. Meanwhile, their relationships with others are also passively published to a certain extent when they obtain information from others and interact. As the user posts more information and interacts with others, the user's network image is further enriched, and more information is available to determine the user's identity. Thousands of users publish information on platforms. Through analysis and filtration of data, identity information, relationship information and other privacy data of the users may be obtained, resulting in disclosure of user privacy. Therefore, how to protect the privacy of user data while ensuring the usability of published data has become a constant concern.

### SUMMARY

In view of this, the objective of the present invention is to provide a method for modifying a mobile social network graph based on matrix operations, which uses a matrix form to reflect the topological relationships of the network, has good operational performance, and can directly reflect the relationships between nodes. Meanwhile, the distance between edge-connected nodes may be limited by the number of hops of an accessibility matrix, thereby ensuring the availability of a modified graph, and effectively improving the modification efficiency.

To achieve the above objective, the present invention adopts the following technical solution:

A matrix operation-based method for modifying a mobile social network graph, including the following steps:
step S1: obtaining an accessibility matrix set A of a social network graph to be modified;
step S2: determining information to be modified for each node in the social network graph to be modified, and creating a List to be modified;
step S3: for each node in the social network graph to be modified, determining whether edge adding is required according to the List to be modified; if the edge adding is required, sequentially determining whether there are nodes requiring the edge adding in a two-hop neighbor to a five-hop neighbor according to the accessibility matrix set; if there are nodes requiring the edge adding in the two-hop neighbor to the five-hop neighbor, adding an edge between two nodes, and updating values of the two nodes in the List to be modified; and if adding an edge does not make the current node value zero in the List, skipping the node, and continuing to search for nodes requiring edge adding in the List; and
step S4: if there is still a non-zero value in the List after all nodes are traversed, directly adding Max(List) nodes to a network, and randomly performing edge connection between the added nodes and nodes still requiring edge adding, so that all values in the List are zero, thereby completing graph modification.

Further, the accessibility matrix set A, specifically, for any social network graph to be modified, the accessibility matrix set A={A₂, A₃, A₄, A₅} refers to a set consisting of a two-hop-only accessibility matrix to a five-hop-only accessibility matrix corresponding to the graph to be modified.

Further, the step S2 specifically includes:
S201: representing, by using a feature distribution of a node and a neighbor node thereof, a feature sequence of the current node, determining the similarity by using a relative entropy model, and finally classifying nodes in the graph into a plurality of similar classes according to a feature distribution of a neighbor sub-graph thereof, where each class includes a plurality of similar nodes with the high structural similarity; and
S202: for each class, determining a node max with the largest degree, where for the remaining node i in the class, a value of List[i] is a difference between the degree of the node max and the degree of the node i.

Further, the step S3 specifically includes:
S301: traversing each node i in the graph, and if a value of List[i] is greater than zero, starting to perform edge adding;
S302: setting N=2, and exiting if a value of N is 6;
S302: searching an N-hop-only accessibility matrix for a row or column corresponding to the node i, to obtain an N-hop neighbor set P of the node i; and
S303: traversing a node j in P, and if a value of List[j] is greater than zero, adding an edge between the node i and the node j, and subtracting 1 from the values of List[i] and List[j]; if the value of List[i] is zero, ending edge adding of a current node, and continuing to perform step 301; and if the value of List[if] is not zero, adding 1 to the value of N, and repeatedly performing S302.

Further, the step S4 specifically includes:
S401: finding a maximum Max in the List;
S401: adding Max isolated nodes to a network; and
S402: traversing the List to be modified to find nodes still requiring edge adding, and randomly performing edge connection between these nodes and the isolated nodes, where the number of added connecting edges is a value corresponding to List[i], so that all values in the List are zero, thereby completing graph modification.

A matrix operation-based system for modifying a mobile social network graph, including a processor, a memory, and a computer program stored on the memory, where the processor, when executing the computer program, specifically performs the steps in the matrix operation-based method for modifying a mobile social network graph described as above.

Compared with the prior art, the present invention has the following beneficial effects:
The present invention uses a matrix form to reflect the topological relationships in the network, which has excellent operational performance and can directly reflect the relationship between the nodes. Meanwhile, the distance between the edge-connected nodes may be limited by the number of hops of the accessibility matrix, thereby ensuring the availability of the modified graph, and effectively improving the modification efficiency of the mobile social network graph.

### BRIEF DESCRIPTION OF THE DRAWINGS

FIG. 1 is a flowchart of the present invention;

FIG. 2 is a relationship diagram of a two-hop-only accessibility matrix, a three-hop-only accessibility matrix, and a network topology in an embodiment of the present invention;

FIG. 3 is a schematic diagram of nodes and an n-hop neighbor in an embodiment of the present invention; and

FIG. 4 is a schematic diagram of random edge connection between nodes and an isolated node set in an embodiment of the present invention.

### DETAILED DESCRIPTION OF THE EMBODIMENTS

The present invention is further described below in conjunction with the accompanying drawings and the embodiments.

In this embodiment, an undirected graph G(V, E) is set, where V is a set of all nodes in the graph, and E is a set of all edges in the graph. An accessibility matrix is divided into four levels according to a length of an accessibility path. It is defined that if an element a_{i,j}=1 in the matrix represents that there is only a two-hop path from a node i to a node j, the current matrix is called a two-hop-only accessibility matrix; if the element a_{i,j}=1 in the matrix represents that there is only a three-hop path and are no paths below three hops from the node i to the node j, the current matrix is called a three-hop-only accessibility matrix; if the element a_{i,j}=1 in the matrix represents that there is only a four-hop path and are no paths below four hops from the node i to the node j, the current matrix is called a four-hop-only accessibility matrix; and if the element a_{i,j}=1 in the matrix represents that there is only a five-hop path and are no paths below four hops from the node i to the node j, the current matrix is called a five-hop-only accessibility matrix.

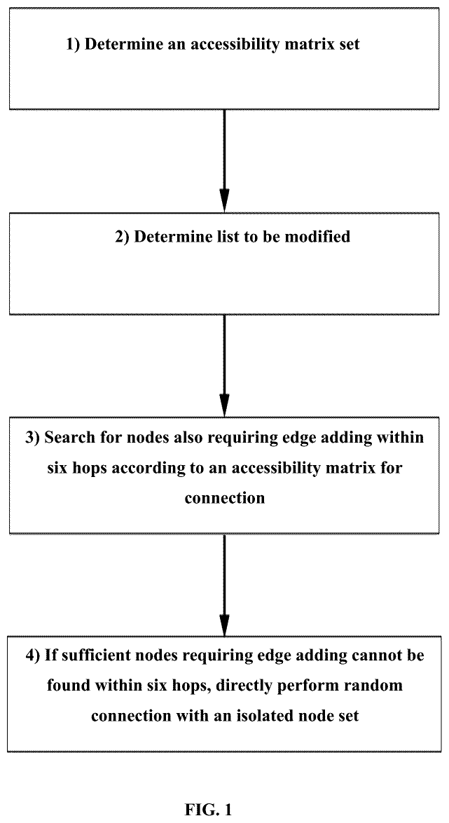

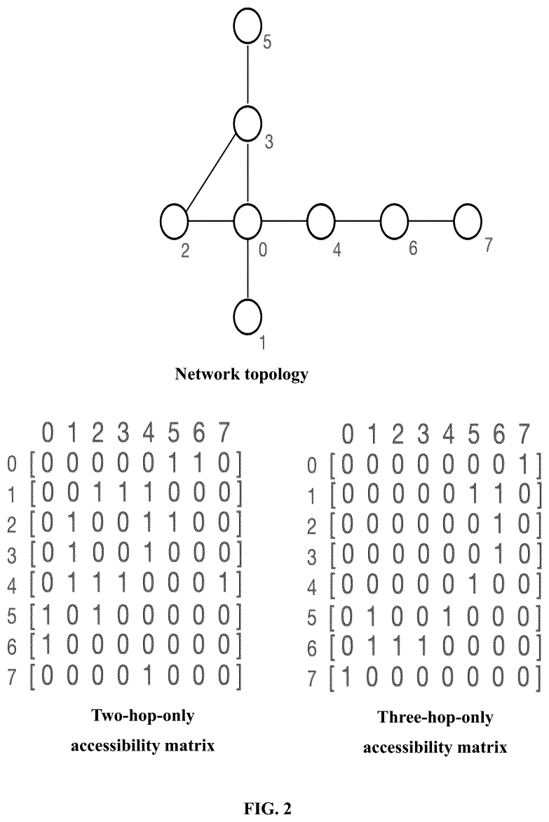

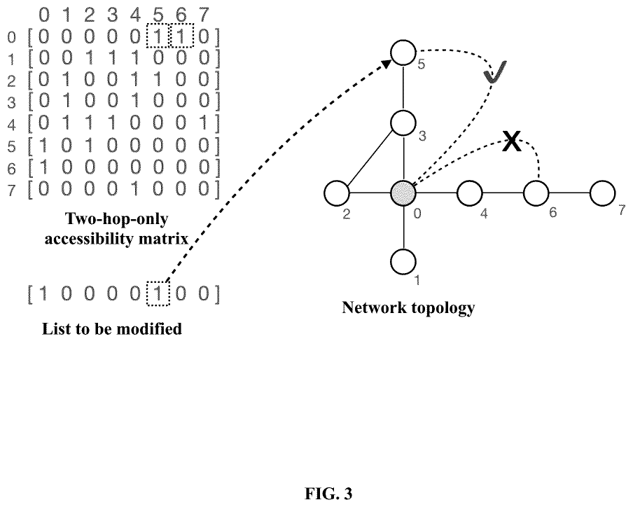

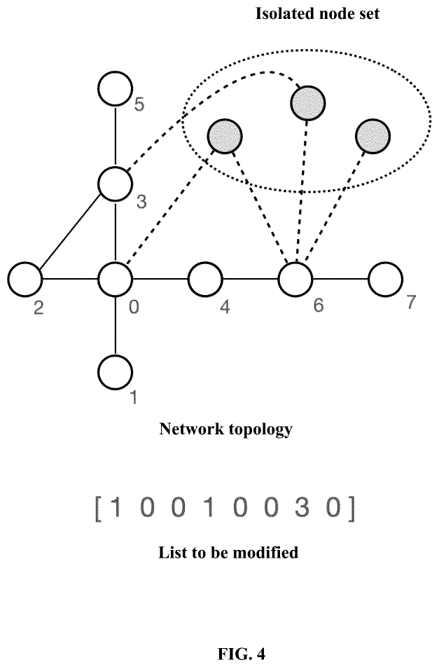

Referring to FIG. 1, the present invention provides a matrix operation-based method for modifying a mobile social network graph, including the following steps:
S1: determining an accessibility matrix set A as shown in FIG. 2. For any social network graph to be modified, the accessibility matrix set A={A₂, A₃} refers to a set consisting of a two-hop-only accessibility matrix to a three-hop-only accessibility matrix corresponding to a graph to be modified.
S2: determining information to be modified for each node in the original graph, and creating a List to be modified. Nodes in the graph are classified into a plurality of classes, and degrees of the nodes in the same class are modified to be the maximum degree of the nodes in the current class. Therefore, for any node i in the graph, a value of List[i] to be modified stores the number of edges required to be added for the node i.
S3: as shown in FIG. 3, for each node in the graph, determining whether edge adding is required according to the List to be modified; if the edge adding is required, sequentially determining whether there are nodes requiring the edge adding in a two-hop neighbor to a five-hop neighbor according to the accessibility matrix set; if there are nodes requiring the edge adding in the two-hop neighbor to the five-hop neighbor, adding an edge between two nodes, and updating values of the two nodes in the List to be modified; and if adding an edge does not make the current node value zero in the List, skipping the node, and continuing to search for nodes requiring edge adding in the List.
S4: as shown in FIG. 4, if there is still a non-zero value in the List after all nodes in the List are traversed, directly adding Max(List) nodes to a network, and randomly performing edge connection between the added nodes and nodes still requiring edge adding, so that all values in the List are zero, thereby completing graph modification.

Preferably, in this embodiment, the step S2 specifically includes the following steps:
S201: representing, by using a feature distribution of a node and a neighbor node thereof, a feature sequence of the current node, determining the similarity by using a relative entropy model, and finally classifying nodes in the graph into a plurality of similar classes according to a feature distribution of a neighbor sub-graph thereof, where each class includes a plurality of similar nodes with the high structural similarity.
S202: for each class, determining a node max with the largest degree, where for the remaining node i in the class, a value of List[i] is a difference between the degree of the node max and the degree of the node i.

Preferably, in this embodiment, the step S3 specifically includes the following steps:
S301: traversing each node i in the graph, and if a value of List[i] is greater than zero, starting to perform edge adding.
S302: setting N=2, and exiting if a value of N is 6.
S302: searching an N-hop-only accessibility matrix for a row or column corresponding to the node i, to obtain an N-hop neighbor set P of the node i.
S303: traversing a node j in P, and if a value of List[j] is greater than zero, adding an edge between the node i and the node j, and subtracting 1 from the values of List[i] and List[j]. If the value of List[i] is zero, ending edge adding of a current node, and continuing to perform step 301. If the value of List[i] is not zero, adding 1 to the value of N, and repeatedly performing step S302.

Preferably, in this embodiment, the step S4 specifically includes the following steps:
S401: finding a maximum Max in the List.
S401: adding Max isolated nodes to a network.
S402: traversing the List to be modified to find nodes still requiring edge adding, and randomly performing edge connection between these nodes and the isolated nodes, where the number of added connecting edges is a value corresponding to List[i], so that all values in the List are zero, thereby completing graph modification.

The present invention adopts the above technical solution. In the process of graph modification, the nodes requiring edge adding in the original graph are found by using the list to be modified, the nodes also requiring edge adding in six hops of the nodes requiring edge adding are found according to the accessibility matrix to perform edge connection, and if sufficient matching nodes cannot be found in six hops, the found nodes are directly connected to an isolated node set, so that all the nodes in the whole graph meet edge adding requirements, thereby completing the graph modification. The present invention has the following beneficial effects: 1. An adjacency matrix of the graph, a graph relationship structure with excellent performance and convenient calculation, is studied. 2. A distance between two nodes connected to each other is limited by the number of hops of the accessibility matrix, thus ensuring that a shortest path of the graph changes less compared with a randomly added edge. 3. By adding the edge to the nodes, the nodes in the same class have the structural similarity, thereby protecting the privacy of the nodes. 4. The modified graph with the higher availability is obtained, and meanwhile the graphs before and after modification are probabilistically indistinguishable.

Those skilled in the art should understand that embodiments of the present application can be provided as a method, a system, or a computer program product. Therefore, the present application may be in the form of a pure hardware embodiment, a pure software embodiment, or an embodiment combining software and hardware. Furthermore, the present application may be in the form of a computer program product executed by one or more computer-usable storage media containing computer-usable program codes therein (including but not limited to a magnetic disk memory, a CD-ROM, an optical memory and the like).

The present application is described with reference to the flowchart and/or the block diagram of the method, the device (system), and the computer program product according to the embodiments of the present application. It should be understood that each process and/or block in the flowchart and/or the block diagram and combination of processes and/or blocks in the flowchart and/or the block diagram may be implemented by computer program instructions. These computer program instructions may be provided to a general-purpose computer, a special-purpose computer, an embedded processor, or a processor of other programmable data processing equipment so as to give rise to a machine with the result that the instructions executed by the computer or the processor of other programmable data processing equipment give rise to a device that is configured to implement the functions designated by one or more processes in the flowchart and/or one or more blocks in the block diagram.

These computer program instructions may also be stored in a computer-readable memory that can direct the computer or other programmable data processing equipment to function in a particular manner, such that the instructions stored in the computer-readable memory produce a manufactured article including an instruction device that implements the functions designated by one or more processes in the flowchart and/or one or more blocks in the block diagram.

These computer program instructions may also be loaded on the computer or other programmable data processing equipment to perform a series of operation steps on the computer or other programmable equipment to generate the process implemented by the computer, so that the instructions executed by the computer or other programmable equipment provide steps that are used to implement the functions designated by one or more processes in the flowchart and/or one or more blocks in the block diagram.

The above are merely the preferred embodiments of the present invention, and are not intended to limit the present invention in other forms. Any those skilled in the art may use the technical content disclosed above to change or modify them to equivalent embodiments with equivalent changes. However, any simple amendments, equivalent changes and modifications made to the above embodiments according to the technical essence of the present invention without departing from the content of the technical solution of the present invention still fall within the scope of protection of the technical solution of the present invention.

1. A matrix operation-based method for modifying a mobile social network graph, comprising the following steps:
step S1: obtaining an accessibility matrix set A of a social network graph to be modified;
step S2: determining information to be modified for each node in the social network graph to be modified, and creating a List to be modified;
step S3: for each node in the social network graph to be modified, determining whether edge adding is required according to the List to be modified; if the edge adding is required, sequentially determining whether there are nodes requiring the edge adding in a two-hop neighbor to a five-hop neighbor according to the accessibility matrix set; if there are nodes requiring the edge adding in the two-hop neighbor to the five-hop neighbor, adding an edge between two nodes, and updating values of the two nodes in the List to be modified; and if adding an edge does not make the current node value zero in the List, skipping the node, and continuing to search for nodes requiring edge adding in the List; and
step S4: if there is still a non-zero value in the List after all nodes are traversed, directly adding Max(List) nodes to a network, and randomly performing edge connection between the added nodes and nodes still requiring edge adding, so that all values in the List are zero, thereby completing graph modification.

2. The matrix operation-based method for modifying the mobile social network graph according to claim 1, wherein the accessibility matrix set A, specifically, for any social network graph to be modified, the accessibility matrix set A {A₂, A₃, A₄, A₅} refers to a set consisting of a two-hop-only accessibility matrix to a five-hop-only accessibility matrix corresponding to the graph to be modified.

3. The matrix operation-based method for modifying the mobile social network graph according to claim 1, wherein the step S2 further comprises:
S201: representing, by using a feature distribution of a node and a neighbor node thereof, a feature sequence of the current node, determining the similarity by using a relative entropy model, and finally classifying nodes in the graph into a plurality of similar classes according to a feature distribution of a neighbor sub-graph thereof, wherein each class comprises a plurality of similar nodes with the high structural similarity; and
S202: for each class, determining a node max with the largest degree, wherein for the remaining node i in the class, a value of List[i] is a difference between the degree of the node max and the degree of the node i.

4. The matrix operation-based method for modifying the mobile social network graph according to claim 1, wherein the step S3 further comprises:
S301: traversing each node i in the graph, and if a value of List[i] is greater than zero, starting to perform edge adding;
S302: setting N×2, and exiting if a value of N is 6;
S302: searching an N-hop-only accessibility matrix for a row or column corresponding to the node i, to obtain an N-hop neighbor set P of the node i; and
S303: traversing a node j in P, and if a value of List[j] is greater than zero, adding an edge between the node i and the node j, and subtracting 1 from the values of List[i] and List[j];
if the value of List[i] is zero, ending edge adding of a current node, and continuing to perform step 301; and if the value of List[i] is not zero, adding 1 to the value of N, and repeatedly performing S302.

5. The matrix operation-based method for modifying the mobile social network graph according to claim 1, wherein the step S4 further comprises:
S401: finding a maximum Max in the List;
S401: adding Max isolated nodes to a network; and
S402: traversing the List to be modified to find nodes still requiring edge adding, and randomly performing edge connection between these nodes and the isolated nodes, wherein the number of added connecting edges is a value corresponding to List[i], so that all values in the List are zero, thereby completing graph modification.

6. A matrix operation-based system for modifying a mobile social network graph, comprising a processor, a memory, and a computer program stored on the memory, wherein the processor, when executing the computer program, specifically performs the steps in the matrix operation-based method for modifying the mobile social network graph according to claim 1.

7. A matrix operation-based system for modifying a mobile social network graph, comprising a processor, a memory, and a computer program stored on the memory, wherein the processor, when executing the computer program, specifically performs the steps in the matrix operation-based method for modifying the mobile social network graph according to claim 2.

8. A matrix operation-based system for modifying a mobile social network graph, comprising a processor, a memory, and a computer program stored on the memory, wherein the processor, when executing the computer program, specifically performs the steps in the matrix operation-based method for modifying the mobile social network graph according to claim 3.

9. A matrix operation-based system for modifying a mobile social network graph, comprising a processor, a memory, and a computer program stored on the memory, wherein the processor, when executing the computer program, specifically performs the steps in the matrix operation-based method for modifying the mobile social network graph according to claim 4.

10. A matrix operation-based system for modifying a mobile social network graph, comprising a processor, a memory, and a computer program stored on the memory, wherein the processor, when executing the computer program, specifically performs the steps in the matrix operation-based method for modifying the mobile social network graph according to claim 5.
